(19) United States
(12) Patent Application Publication
(10) Pub. No.: US 2001/0050289 A1
(43) Pub. Date: Dec. 13, 2001

(54) A TOP FOR CONTAINERS

(76) Inventor: CLAUS CORDES, VECHTA (DE)

Correspondence Address: D BRUCE PROUT, CHRISTIE PARKER & HALE, PO BOX 7068, PASADENA, CA, 911097068

(21) Appl. No.: 09/308,191

(22) PCT Filed: Nov. 10, 1997
(86) PCT No.: PCT/EP97/06223

§ 371 Date: None

(30) Foreign Application Priority Data
Nov. 11, 1996 (DE) 296 19 566.9

(51) Int. Cl. B65D 5/66; B67D 1/00

(52) U.S. Cl. 222/39; 222/78; 222/113; 340/603

(57) ABSTRACT

The present invention relates to a top for a container such as bottles or cans for pouring out liquids. To create an advertising medium, which can be produced economically and triggers a higher awareness effect than known advertising media of this type, it comprises a voltage source (10), at least one switching element (12), a signal generating device (14) connected thereto and a device for emitting a signal (16, 18) as a reaction to the actuation of the switching element (12).

The present invention relates to a top for a container such as bottles or cans for pouring out liquids. Such tops are used to facilitate the pouring out of liquids, in particular into glasses, and to avoid a spillage of liquids upon pouring out. Such tons are generally known and are widely used, for example, in gastronomic establishments, but also in domestic use, as pouring devices or so-called dispensers.

Furthermore, on such tops is also known the integral forming of additional, substantially two-dimensional elements which may serve as advertising media and may be provided with symbols to refer to specific marks and articles. However, here the advertising effect is restricted to the essentially two-dimensional representation of a symbol which is known or is to be made known. In this case one disadvantage is the fact that, for example, in restaurants bottles having such tops are situated only in the region of the bar and are not noticed by many guests, with the result that the attention effect is slight.

Therefore it is an object of the present invention to create an advertising medium which can be produced economically and elicits a higher degree of attention than known advertising media of this type.

For this purpose in accordance with the invention the top comprises a voltage source, at least one switching element and a signal generating device connected thereto and a device for emitting a signal an a reaction to the actuation of the switching element. According to the possible triggers for this switching element, a signal can consequently be emitted in determined situations, e.g. upon the handling of the container when pouring out.

In a particularly preferred embodiment of the invention, the signal is an acoustic and/or an optical and/or an electromagnetic signal. By the emission of an acoustic and/or an optical signal, a substantially higher awareness effect is achieved than by the mere representation of a symbol, as in this case an acoustic/optical action is triggered, which is more discernible than a mere display of an image. By the emission of an electromagnetic signal it is possible to detect and automatically perceive the handling of the container, e.g. when pouring out.

The switching element, the signal generating device and the device for the emission of the signal and/or the voltage source are, as a particular preference, integrated in the top and thus form a unit which is uncomplicated to handle and can be easily exchanged.

In a further preferred embodiment, the top encases an inner part having a pouring conduit and one or several outer parts which at least partly enclose the inner part. As a result, on the one hand it is possible in a simple manner to give the top an external shape which in identical to a known object or an object to be promoted. One the other hand, the outer parts may form in their interior a Cavity in which the voltage source, the switching element, the signal generating device and the device for emitting the signal can be easily discerned.

In a particularly preferred embodiment of the invention, the inner part has a uniform shape onto which the various outer parts can be placed. As a result it is possible, in a simple manner, to produce a desired external shape with a standardised inner part, in which one or more correspondingly constructed outer parts are joined to the inner part. With a required alteration in the outer shape it is consequently possible to adapt just the otter parts accordingly and to then place them as desired on the inner part.

In a further preferred embodiment the voltage source and/or the switch and/or the signal generating device and/or the device for emitting the signal is at least partially enclosed with a protective covering. In this manner a penetration of liquid and an associated disturbance of the function of the electrical components can be prevented.

An exemplified embodiment of the invention is explained in further detail below. Here:

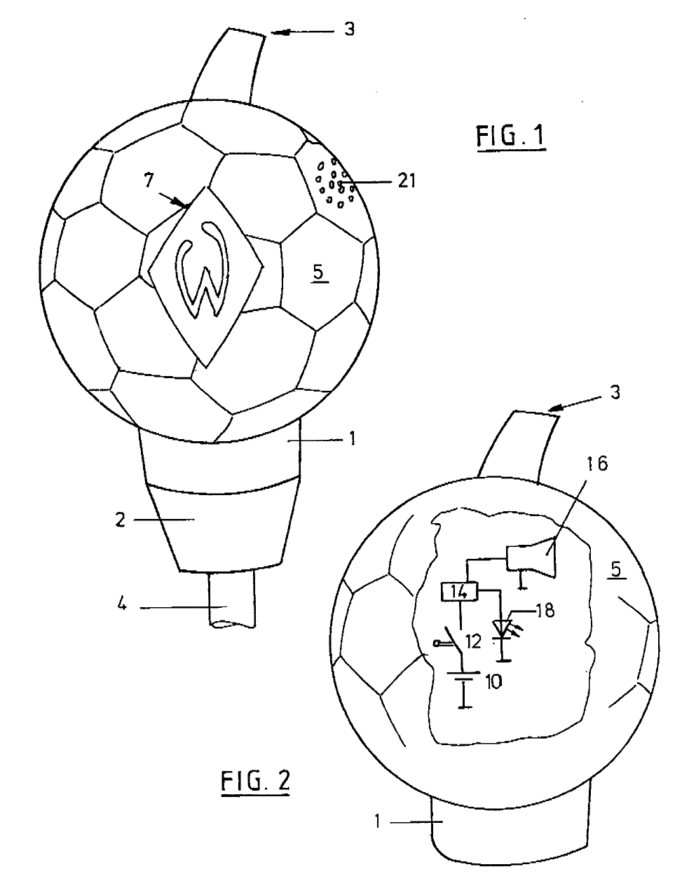

FIG. 1 shows an example of an embodiment of the top according to the invention;

FIG. 2 shows a partly cut-open view of FIG. 1;

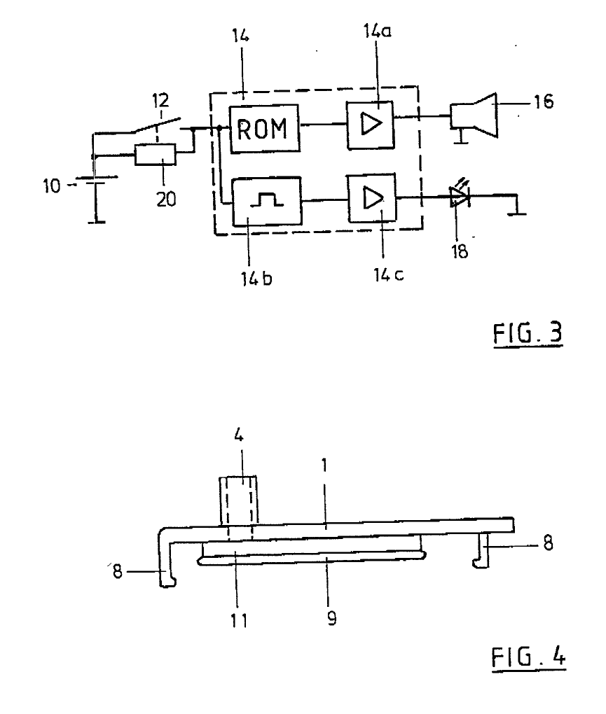

FIG. 3 shows a block diagram of the top according to the invention;

FIG. 4 shows a simplified side view of a further top according to the invention.

In FIG. 1, reference number 1 denotes a base, which may serve, for example, as a support for an outer, shaped part 5, which here is represented in the form of a football and has an emblem 7. The emblem 7 may have a translucent design and thus allows the omission of optical signals by a light source provided in the interior of the top, such as, for example, a light-emitting diode (LED). Reference number 2 denotes a conical stopper, which closes the opening of the bottle neck when the top is placed onto the bottle, and reference number 3 denotes a pouring opening.

In FIG. 2 the outer part 5 is partly cut open. Provided inside the outer part 5 is a voltage source 10 in the form of a button cell. Furthermore, a signal generating device 14 is provided, which may be designed as, an integrated circuit. Disposed between the voltage source 10 and the signal generating device 14 is a switching element 12. This switching element 12 may be a slope switch, which, when it falls below a predetermined angle of inclination of the top, interrupts the electrical connection between the voltage source 10 and the integrated circuit 14 and, when it exceeds a predetermined angle of inclination of the top, again produces this electrical connection. Connected to the integrated circuit 14 is a loudspeaker 16 for reproducing acoustic signals and a light-emitting diode 18 for emitting optical signals.

In this case the light-emitting diode 13 is disposed so that it is adjacent to the translucent emblem 7, so that the light emitted by the light-emitting diode 13 can be clearly discerned from outside. The light-emitting diode 18 can emit the light for a predetermined time interval with a uniform brightness or with varying brightness.

In the present embodiment, the inner part consists of the base 1, the stopper 2 and the pouring conduit 4 with the pouring opening 3. The pouring conduit 4, as a component the inner part of the top, passes through the outer part 5 of the top from the base 1 to the pouring opening 3 and permits a pouring out of the liquid.

As long as the bottle 14 vertical, the switching element in its position of rest in which the connection between the voltage source 10 and the signal generating device is interrupted, as the predetermined angle of inclination is not reached. In the bottle and thus the top is now tilted to pour liquid through the pouring opening 3. The switching element 12, upon the predetermined angle of inclination being exceeded, comes by the action of gravity into its operating position and produces a connection between the voltage source 10 and the signal generating device 14, which as a result is set in operation. Consequently the signal generating device 14 can generate and emit signals which can be discerned outside the top via the connected loudspeaker 16 and/or the connected light-emitting diode 18.

FIG. 3 is a block diagram of a top according to the invention. The voltage source 10 is connected via the switching element 12 to the signal generating device 14, whereby the connection between the voltage source 10 and the signal generating device 14 can be produced and interrupted by the switching element 12. By actuating the switching element 12 and producing the connection between the voltage source 10 and the signal generating device 14, the latter is set in operation and generates the signals to be emitted.

The signal generating device 14 consists of a signal memory (ROM) after which an amplifier 14a is connected, to which a loudspeaker 16 for emitting acoustic signals is in turn connected. At the same time a clock pulse generator 14b with a driver 14c connected after it can be provided to control a light-omitting diode 18.

Provided parallel to the switching element may be a timer 20, which, after actuation of the switching element 12, supplies the signal generating device 14 for a predetermined time period with voltage, so that the signal are emitted for this predetermined time.

FIG. 4 shows another embodiment of the top according to the invention. This embodiment is provided in particular as a top for drink cans. This top comprises a base 1, on which the retention elements 8 are integrally formed in one piece. Those retention elements 8 encircle the upper rim of the drinks can and thus secures the top on the can. A retention element 11 is also integrally formed in one piece on the base 1. Provided on the side of the retention element 11 facing the can is a seal 9, which seals around the opening of the can to prevent a leakage of the liquid past the pouring conduit 4.

Provided inside the base 1 may be a chamber 6 for accommodating the voltage source 10, the switching element 12, the signal generating device 14, the loudspeaker 16 and the light-emitting diode 18. Alternatively these elements could be accommodated inside the supporting ring 11.

In all embodiments of the invention it is possible for the voltage source to, the switch 12, the signal generating device 14, the loudspeaker 16 and the light-emitting diode 18 to be enclosed in fluid-tight manner so as to avoid a malfunction of the electrically powered elements in the event of the unexpected leaking of liquid.

Furthermore, in all embodiments of tho invention it is possible to provide a signal outlet aperture 21. As a result, for example, in the event of a fluid-tight enclosed loudspeaker 16 or with a loudspeaker 16 integrated in the top, an emission of sound through a sound outlet aperture may occur, which is sealed by a semi-permeable film.

1. A top for containers such as bottles or cans, for pouring out liquids, wherein the top comprises a voltage source (10), at least one switching element (12), a signal generating device (14) connected thereto and a device for emitting a signal (16, 18) as a reaction to the actuation of the switching element (12) and the top consists of an inner part having a pouring conduit (4) and at least one outer part (5), which at least partly surrounds the inner part, the correspondingly designed outer part can be joined to the inner part and accommodates the signal is generating device.

2. A top according to claim 1 characterized in that the signal is an acoustic signal and/or an optical signal and/or at electromagnetic signal.

3. A top according to one of the preceding claims, characterized in that the tine duration of the signal can be predetermined.

4. A top according to one of the preceding claims, characterized in that the signal consists of a sequence of individual signals.

5. A top according to one or the preceding claims, characterized in that the switching element (12), the signal generating device (14), the device for emitting the signal (16, 18) and/or the voltage source (10) are integrated in the top.

6. A top according to one of the preceding claims, characterized in that the switching element (12) can be actuated by the action of gravity.

7. A top according to one of the preceding claims, characterized in that the voltage source (10), the switching element (12), the signal generating device (14), the loudspeaker (16) and/or the light-emitting diode (18) are at least partially enclosed in fluid-tight manner.

8. A top according to claim 1, characterized in that the outer parts (5) are securely connected to the inner part.
